(19) United States
(12) Patent Application Publication
(10) Pub. No.: US 2026/0153142 A1
(43) Pub. Date: Jun. 4, 2026

(54) INTEGRAL HEAT EXCHANGER FOR VERTICAL LIFT AIRCRAFT GEARBOXES

(71) Applicant: Lockheed Martin Corporation, Bethesda, MD (US)

(72) Inventors: Ryan Lee Robinson, Aledo, TX (US); William Wolcott, Burleson, TX (US); Zachary Scott Poster, Arlington, TX (US)

(73) Assignee: Lockheed Martin Corporation, Bethesda, MD (US)

(21) Appl. No.: 18/955,770

(22) Filed: Nov. 21, 2024

(51) Int. Cl. F16H 57/04; B64C 27/06; B64C 27/12; B64D 33/08; B64D 35/00; F16H 57/02

(52) U.S. Cl. CPC F16H 57/045; B64C 27/06; B64C 27/12; B64D 33/08; B64D 35/00; F16H 57/02; F16H 57/0413; F16H 57/0416; F16H 2057/02043

(57) ABSTRACT

A gearbox assembly includes a main housing, a plurality of gears, and a lubricant sump. The main housing defines an internal cavity. The gears are disposed within the internal cavity. The lubricant sump is coupled to the main housing. The lubricant sump includes a sump body and a heat exchanger core. The sump body defines a sump cavity and an airflow passage. The sump cavity is fluidly coupled to the internal cavity to collect lubricant used with the gears. The heat exchanger core is coupled to and extends from the sump body and is disposed at least partially within the airflow passage to cool the lubricant passing through the heat exchanger core.

### FIELD

The present disclosure relates generally to the field of heat exchangers for aircraft drive systems.

### BACKGROUND

Aircraft drive systems are configured to transmit power from a motor to various subsystems onboard an aircraft, including propulsion and/or lift systems. Such drive systems may include a gearbox assembly, which may be configured to transmit power from the engine to a vertical lift assembly of the aircraft (e.g., a rotor, etc.), and/or to provide speed and/or torque adjustments to the input power to match the needs of various subsystems onboard the aircraft. Such drive systems may also include a heat exchanger to cool drive system components, including the oil used to lubricate components within the gearbox assembly.

### SUMMARY

Embodiments of the present disclosure relate to a gearbox assembly that includes a heat exchanger that is integrated into at least one housing component of the gearbox assembly. In some embodiments, the heat exchanger is integrated into a lubricant sump of the gearbox assembly that is configured to collect lubricant from the gearbox assembly and to recirculate coolant back toward the gear train disposed within the gearbox. In at least one embodiment, the heat exchanger is integrally formed with the lubricant sump from a single piece of material, such as via an additive manufacturing process.

One aspect of the present disclosure relates to a gearbox assembly that includes a main housing, a plurality of gears, and a lubricant sump. The main housing defines an internal cavity. The gears are disposed within the internal cavity. The lubricant sump is coupled to the main housing. The lubricant sump includes a sump body and a heat exchanger core. The sump body defines a sump cavity and an airflow passage. The sump cavity is fluidly coupled to the internal cavity to collect lubricant used with the gears. The heat exchanger core is coupled to and extends from the sump body and is disposed at least partially within the airflow passage to cool the lubricant passing through the heat exchanger core.

Another aspect of the present disclosure relates to a lubricant sump for a gearbox assembly. The lubricant sump includes a sump body and a heat exchanger core. The sump body defines a flange structured to couple the sump body to a housing of the gearbox assembly. The sump body also defines a sump cavity configured to receive a volume of lubricant therein. The sump body also defines an airflow passage. The heat exchanger core is coupled to and extends from the sump body and is disposed at least partially within the airflow passage to cool the lubricant passing through the heat exchanger core.

Yet another aspect of the present disclosure relates to a method of making a lubricant sump for a gearbox assembly. The method includes forming a sump body defining a flange and a sump cavity. The flange is structured to couple the sump body to a housing of the gearbox assembly. The sump cavity is configured to receive a volume of lubricant therein. The method also includes coupling a heat exchanger core to the sump body so that the heat exchanger core is disposed at least partially within the airflow passage.

This summary is illustrative only and should not be regarded as limiting.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view of a rotary wing aircraft, according to an embodiment.

FIG. 2 is a perspective cross-sectional view of a gearbox assembly of a drive system of a rotary wing aircraft, according to an embodiment.

FIG. 3 is a perspective view of a portion of the gearbox assembly of FIG. 2 inclusive of an oil sump of the gearbox assembly.

FIG. 4 is a side cross-sectional view of the oil sump of FIG. 3.

FIG. 5 is a perspective cross-sectional view of a gearbox assembly of a drive system of a rotary wing aircraft, according to another embodiment.

FIG. 6 is another perspective view of the oil sump of FIG. 3.

FIG. 7 is a front side cross-sectional view of the oil sump of FIG. 3, taken through a flow passage that extends from a sump cavity of the oil sump, according to an embodiment.

FIG. 8 is another perspective view of the oil sump of FIG. 3.

FIG. 9 is a perspective cross-sectional view of the oil sump of FIG. 3, taken through a first flow manifold of the oil sump, according to an embodiment.

FIG. 10 is a perspective cross-sectional view of the oil sump of FIG. 3, taken through a second flow manifold of the oil sump, according to an embodiment.

FIG. 11 is a flow diagram of the heat exchanger core and flow manifolds of the oil sump, according to an embodiment.

FIG. 12 is a perspective view of a heat exchanger portion of the oil sump of FIG. 3, according to an embodiment.

FIG. 13 is a side view of the oil sump of FIG. 3 showing a bypass conduit of the oil sump, according to an embodiment.

FIG. 14 is a side cross-sectional view through the oil sump of FIG. 3, taken through a flow manifold of the oil sump that is adjacent to a bypass conduit of the oil sump, according to an embodiment.

FIG. 15 is a front side cross-sectional view of the oil sump of FIG. 3, taken through a bypass conduit of the oil sump, according to an embodiment.

FIG. 16 is a flow diagram of a method of making an oil sump for a gearbox assembly, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

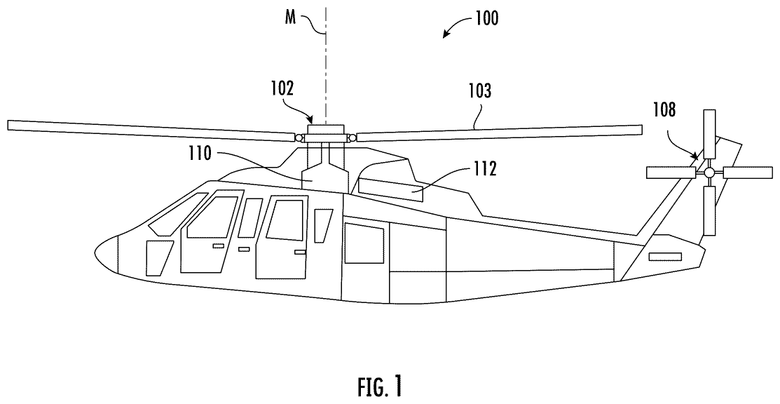

Drive systems for aircraft are used to transfer power from a motor (e.g., an engine, etc.) to various subsystems onboard the aircraft. By way of example, FIG. 1 depicts a rotary wing aircraft 100 (e.g., a rotorcraft, etc.) that includes multiple rotating components that provide lift and maneuverability to the aircraft 100. The aircraft 100 includes a main drive system, shown as main rotor gearbox assembly 110 (also referred to as a first gearbox assembly, a main gearbox assembly, or a first transmission), that is configured to power the main rotor system, main rotor 102, and main rotor blades 103, of the aircraft 100. The aircraft 100 also includes a secondary drive system (which can be an anti-torque system, a propulsor system, or like propulsive system), shown as tail rotor assembly 108, mounted to a tail end portion of the aircraft 100. The main rotor gearbox assembly 110 is driven about a rotor axis of rotation M through the main rotor gearbox assembly 110 by one or more motors 112. The tail rotor assembly 108 is driven about a second rotor axis that is substantially perpendicular to the rotor axis M and is driven through a second gearbox assembly (also referred to as a second transmission). The aircraft 100 may also include other driven components (such as a hydraulic pump) that may be driven by the motor 112 via the first gearbox assembly 110 and/or the second gearbox assembly. While shown in the context of a single main rotor with a tail rotor, it is understood that aspects of the invention can be used in other types of aircraft, including coaxial aircraft with propulsors, tilt rotor aircraft, and fixed wing aircraft.

Each of the first gearbox assembly 110 and the second gearbox assembly includes a gearbox housing (also referred to as a main housing) for supporting the transmission elements (e.g., gears, bearings, shafts,), and for directing the flow of lubricant (e.g., a lubricating fluid, oil, or like fluids) across the transmission elements during operation. In some embodiments, the drive systems for the aircraft 100 also include heat exchangers mounted remotely from the gearbox assemblies that are configured to provide cooling to lubricant circulating through the gearbox assemblies.

Referring generally to the figures, embodiments of the present disclosure relate to a gearbox assembly that includes a heat exchanger that is integrated into at least one housing component of the gearbox assembly. In some embodiments, the heat exchanger is integrated into an oil sump (e.g., an oil sump housing, etc.) of the gearbox assembly that is configured to collect oil from a main gearbox housing and to recirculate coolant back toward the gear train disposed within the main gearbox housing. Beneficially, the oil sump integrated heat exchanger of the present disclosure can reduce the need for split lines and/or sealing members between the heat exchanger and the gearbox housing(s). Such an oil sump integrated heat exchanger can also reduce part count and extraneous mounting structures by utilizing a housing component that is already used for the gearbox assembly. For example, as compared to remote heat exchanger designs (which include a standalone heat exchanger that is separate from the gearbox assembly), the integrated oil sump heat exchangers of the present disclosure reduce the number of fluid transfer lines (e.g., oil lines, etc.), seals, and other fluid transfer equipment, thereby reducing overall part count and system weight. The integrated oil sump heat exchanger can also increase system reliability due to the use of fewer parts as compared to remote and/or standalone heat exchanger designs. The use of fewer parts also reduces the risk of damage and leaks during maintenance events by reducing the number of components that a technician interacts with during repair or replacement of system components.

Although described herein with respect to aircraft applications, it should be understood that the inventive principles disclosed herein are also applicable to drive systems and gearbox assembly designs used in other applications, such as in automotive applications, marine applications, and others.

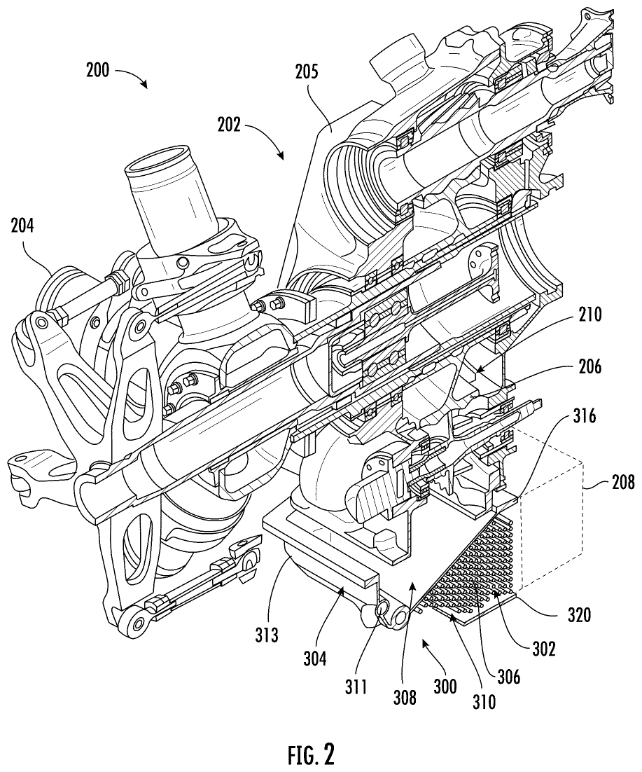

Referring to FIG. 2, a drive system 200 for use with an aircraft, such as the aircraft 100 of FIG. 1 is shown, according to an embodiment. The drive system 200 includes a gearbox assembly 202 that is configured to transmit power from a motor or other energy system to a rotor 204 (e.g., a main rotor, a tail rotor, etc.) of the aircraft to power movement of the aircraft.

The gearbox assembly 202 includes a main housing 205, a plurality of gears 206, and an oil sump 300. In the embodiment of FIG. 2, the gearbox assembly 202 also includes a propeller shaft (e.g., a rotor shaft, a mast, etc.) that is structured to transmit motion from the gears 206 to the rotor 204. The gearbox assembly 202 may also include other shafts and/or power transmission equipment to power other subsystems onboard the aircraft (e.g., pumps, etc.).

The main housing 205 is configured to enclose and support the primary components of the gearbox assembly 202, including the gears 206. The main housing 205 defines an internal cavity 210 (e.g., an interior cavity, a hollow region, etc.). In some embodiments, the main housing 205 includes a plurality of housing sections that together define the internal cavity 210. In some embodiments, the main housing 205 also defines at least one lubricant passageway to facilitate transfer of fluids to different parts of the internal cavity 210.

The gears 206 are disposed within the internal cavity 210 and are configured to transmit power from the motor to different subsystems onboard the aircraft, including the rotor 204. In the embodiment of FIG. 2, at least one of the plurality of gears 206 is configured to power movement of the rotor 204 via a connection to the propeller shaft by means of a spline or other torque carrying connection. In some embodiments, the gearbox assembly 202 also includes at least one gear 206 that is configured to power an electric power generator (e.g., an alternator, etc.) onboard the aircraft, which can be used to power various electrical equipment.

The oil sump 300 is structured to (i) collect and store lubricant (e.g., oil, etc.) received from the internal cavity 210, (ii) cool lubricant via an integral heat exchanger, and (iii) to facilitate redistribution of lubricant to other parts of the gearbox assembly 202. In the embodiment of FIG. 2, the oil sump 300 includes a heat exchanger 302 that is integrated into the oil sump 300 so that the oil sump 300 and the heat exchanger 302 can be installed onto the main housing 205 as a single piece.

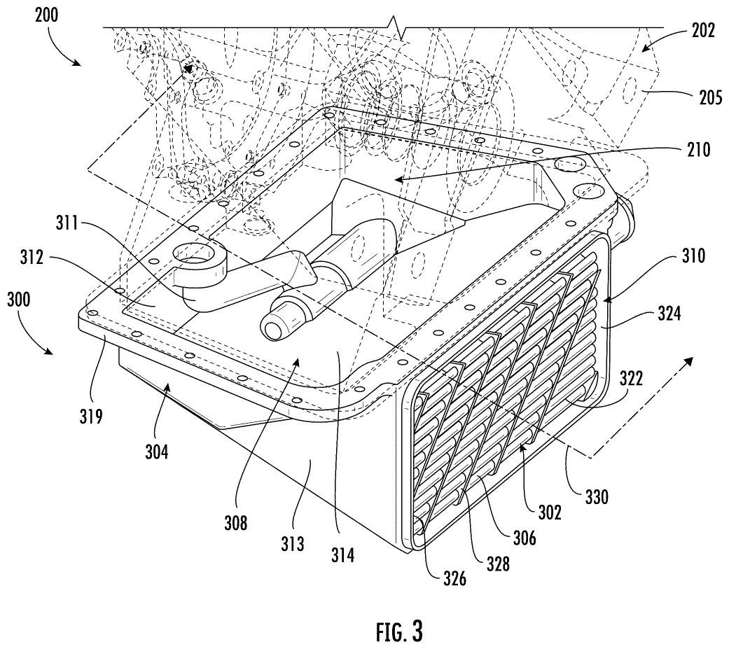

The oil sump 300 includes an oil pan, shown as a sump body 304, and a heat exchanger core 306 that is coupled to the sump body 304. The sump body 304 defines a reservoir, shown as a sump cavity 308; an airflow passage 310; a plurality of fluid conduits 311; and a pair of flow manifolds 313 (also see FIG. 3). In other embodiments, the oil sump 300 may include additional, fewer, and/or different components.

The sump cavity 308 is configured to collect and store lubricant in sufficient quantity to provide a continuous supply of circulating lubricant for the gearbox assembly 202. The sump cavity 308 is fluidly coupled to the internal cavity 210 of the main housing 205 at an open end of the sump cavity 308. The sump cavity 308 is arranged to receive oil from the internal cavity 210 (e.g., via gravity, etc.) during system operation. In the embodiment of FIG. 3, the sump body 304 includes a plurality of sidewalls 312 and a lower wall 314 that together define the sump cavity 308.

The sump body 304 also defines a flange 319 (e.g., a mounting flange, etc.) that defines an open end of the sump cavity 308. The flange 319 extends along a perimeter of the sump cavity 308. The flange 319 defines a sealing surface that is configured to sealingly engage the sump cavity 308 with the main housing 205. The flange 319 also defines a plurality of openings structured to receive mechanical fasteners (e.g., bolts, etc.) therethrough to couple the sump body 304 to the main housing 205.

The airflow passage 310 extends through the sump body 304 and is structured to guide coolant (e.g., ambient air, etc.) from an environment that surrounds the sump body 304 and across the heat exchanger core 306. The airflow passage 310 extends to the outer ends of the sump body 304 and is arranged to receive air directly from a fan or other fluid driver without any intervening components (e.g., without intervening flow conduits, flow distribution baffles, etc.).

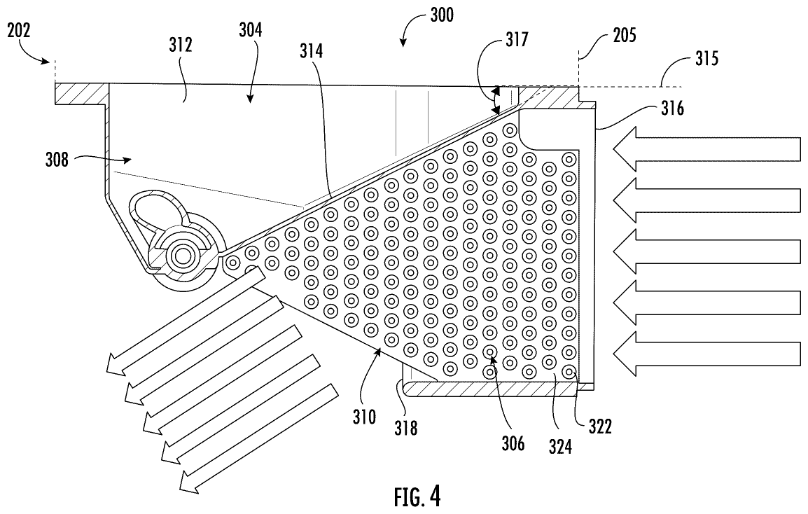

The airflow passage 310 is at least partially defined by the lower wall 314 of the sump body 304 so that the lower wall 314 defines at least a portion of the airflow passage 310 (e.g., an upper wall of the airflow passage 310 that extends along the airflow direction through the airflow passage 310, etc.). As described above, the lower wall 314 also at defines at least a portion of the sump cavity 308. Referring to FIG. 4, the lower wall 314 separates the sump cavity 308 from the airflow passage 310 and prevents lubricant from leaking into the airflow passage 310. The lower wall 314 is in direct fluid communication with both the lubricant in the sump cavity 308 and the coolant (e.g., air, etc.) within the airflow passage 310. Such an arrangement enables cooling of the lubricant through the lower wall 314 during operation, which can improve system performance by reducing the rate at which the temperature of lubricant increases at startup (e.g., by prolonging operation of the system under bypass conditions as will be further described). The arrangement of the lower wall 314 of the sump body 304 can also help cool the lubricant disposed in the sump cavity 308 before entering the heat exchanger core 306, which can improve heat exchanger efficiency and/or allow for a smaller volume and/or number of heat exchanger cores.

The airflow passage 310 is suspended away from the main housing 205 by the sump body 304 and is in direct fluid receiving arrangement with ambient air surrounding the gearbox assembly 202 (also see FIG. 3). Beneficially, such an arrangement can more efficiently dissipate heat from the gearbox assembly 202 because the airflow passage 310 disposed farther away the gears 206 and other heat generating components of the gearbox assembly 202. Such an arrangement of the airflow passage 310 also allows for coolant (e.g., air, etc.) to flow around the full circumference of the heat exchanger core 306 and individual tubes 322 of the heat exchanger core 306 during system operation.

In some embodiments, the lower wall 314 extends at an angle 317 relative to a reference plane 315 passing along a sealing surface between the sump body 304 and the main housing 205. In such implementations, the coolant (e.g., air) passing through the airflow passage 310 is directed toward and across the lower wall 314, which can improve cooling performance of the heat exchanger 302 by providing direct cooling of oil in contact with the lower wall 314.

The airflow passage 310 extends between a first housing opening 316 (e.g., a forward opening, etc.) at a first end of the airflow passage 310 and a second housing opening 318 (e.g., an aft opening, etc.) at a second end of the airflow passage 310. In the embodiment of FIG. 4, the first housing opening 316 is oriented substantially normal to the reference plane 315. The second housing opening 318 is oriented at an angle relative to the first housing opening 316. Such an arrangement can, beneficially, provide an increased length of the airflow passage 310 for a given size of the oil sump 300.

Referring again to FIG. 2, in some embodiments, the sump body 304 includes a flange 320 that defines the first housing opening 316. The flange 320 is structured to support a fan 208 thereon and to couple the fan 208 to the sump body 304. In the embodiment of FIG. 2, the fan 208 is an axial fan that configured to direct ambient air through the airflow passage 310. In other embodiments, the fan 208 may be another type of air or fluid driver (e.g., a centrifugal fan, a pump, etc.).

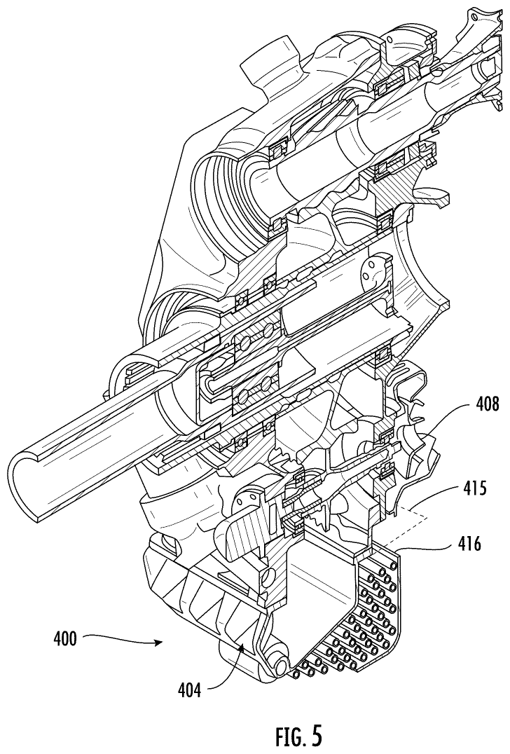

In other embodiments, the arrangement of the first housing opening 316 and the second housing opening 318 may be different. For example, referring to FIG. 5, an oil sump 400 for a gearbox assembly is shown that defines a first opening 416 that extends substantially parallel to a reference plane 415 passing along a sealing interface between a sump body 404 and a main housing of the gearbox assembly. Beneficially, such an arrangement can enable the use of a centrifugal fan 408 that is powered directly by the gearbox assembly. In other embodiments, the design of the sump body may be different from that shown in FIG. 2 or FIG. 4.

Referring back to FIG. 4, the heat exchanger core 306 is coupled to the sump body 304 and is disposed at least partially within the airflow passage 310. The sump body 304 supports the heat exchanger core 306 external to the sump cavity 308 and the walls of the main housing 205 in a low stress area outside of primary load areas of the gearbox assembly 202. Beneficially, such an arrangement can reduce the risk of cracks in the pressurized passages of the heat exchanger core 306. Additionally, in the embodiment of FIG. 4, the heat exchanger core 306 does not add or require an increase in thickness to the walls of the main housing 205 and/or the sump body 304, which can reduce the overall space claim of the gearbox assembly 202 onboard the aircraft.

In some embodiments, the oil sump 300 includes a plurality of heat exchanger cores and/or core portions that are disposed within the airflow passage 310. In the embodiment of FIGS. 3-4, the heat exchanger core 306 includes a plurality of tubes 322 that extend across the airflow passage 310, from a first sidewall 324 of the airflow passage 310 to a second sidewall 326 of the airflow passage 310 that is opposite from the first sidewall 324. In the embodiment of FIGS. 3-4, the tubes 322 are cylindrical tubes that extend substantially parallel to one another across an entire width of the airflow passage 310. In some embodiments, the heat exchanger core 306 and sump body 304 together define a shell and tube heat exchanger arrangement. In other embodiments, the oil sump 300 may include another type of heat exchanger 302 geometry.

Referring to FIG. 3, the heat exchanger core 306 also includes a plurality of baffles 328 (e.g., support panels, fin supports, etc.). In the embodiment of FIG. 3, the baffles 328 are elongated panels that extend along an airflow direction 330 through the airflow passage 310. In some embodiments, the baffles 328 are spaced apart from one another in approximately equal increments along the width of the airflow passage 310.

The baffles 328 are structured to maintain approximately uniform separation between adjacent ones of the tubes 322 of the heat exchanger core 306. The baffles 328 also increase the strength of the heat exchanger core 306. The baffles 328 can also stabilize and support the tubes 322 relative to one another during manufacturing operations, such as during an additive manufacturing operation, without requiring separate fixturing and/or material supports.

In the embodiment of FIGS. 3-4, the heat exchanger core 306 is integrally formed with the sump body 304 from a single piece of material (e.g., aluminum, steel, or another metallic material). For example, the heat exchanger core 306 and sump body 304 may be integrally formed by an additive manufacturing process.

In at least one embodiment, the additive manufacturing process is a laser powder bed fusion (LPBF) process that is configured to deposit and fuse a material powder layer-by-layer to form a solid part. The LPBF process may be a selective laser sintering (SLS) process, a selective laser melting (SLM) (e.g., a direct metal laser sintering (DMLS)) process, an electron beam melting (EBM) process, and/or another type of laser-sintered and/or powder fusion operation. In other embodiments, the additive manufacturing process is a wire arc additive manufacturing (WAAM) process (e.g., a laser directed energy deposition (L-DED) process, a laser wire directed energy deposition (LW-DED) process, etc.), or another type of additive manufacturing process now known or hereafter developed that may be used to generate such geometries.

In yet other embodiments, the heat exchanger core 306 and the sump body 304 may be integrally formed by a casting operation (e.g., sand casting, investment casting, etc.). In yet other embodiments, the heat exchanger core 306 or portions thereof may be formed separately from the sump body 304 and coupled to the sump body 304 via a welding and/or brazing process, or another permanent coupling operation. Beneficially, integrating the heat exchanger core 306 with the oil sump 300 as a single monolithic body can simplify assembly operations, and can reduce the number of fluid connections between the heat exchanger and other components of the gearbox assembly 202 (e.g., the main housing 205, the oil sump 300, etc.).

In the embodiment of FIGS. 3-4, the sump body 304 also defines a plurality of fluid conduits 311 that are integrally formed with the sump body 304. The fluid conduits are structured to fluidly couple the sump cavity 308 to other parts of the gearbox assembly 202.

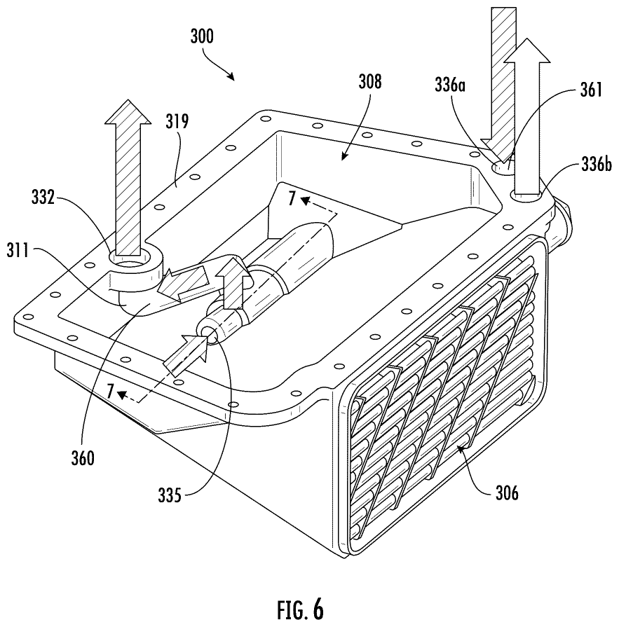

Referring to FIG. 6, the plurality of fluid conduits 311 define a plurality of fluid passageways 332 that are configured to fluidly couple the oil sump 300 to the main housing 205 and/or other components of the drive system 200 (see also FIG. 3). In the embodiment of FIG. 6, the sump body 304 includes a first conduit 360 defining a first passageway 335 (e.g., an oil collection passageway, etc.) that is fluidly coupled to the sump cavity 308. The sump body 304 also includes a second conduit 361 defining a second passageway 336 (e.g., a heat exchanger passageway, etc.) that is fluidly coupled to the heat exchanger core 306 (e.g., to a flow manifold upstream and/or downstream of the heat exchanger core 306 on a tube side of the heat exchanger core 306).

The first passageway 335 and the second passageway 336 extend through the flange 319 at an open end of the sump cavity 308. In the embodiment of FIG. 6, the flange 319 defines an axially facing sealing surface that is configured to sealingly engage the first passageway 335 and the second passageway 336 with other components of the gearbox assembly 202 (e.g., the main housing, etc.).

The first passageway 335 is configured to guide hot lubricant (e.g., hot oil, etc.) from the sump cavity 308 to the second passageway 336. In some embodiments, the first passageway 335 is configured to deliver the hot lubricant to a lubricant filtration system upstream of the second passageway 336. The lubricant filtration system may include a lubricant filter (e.g., an oil filter, etc.) that is configured to remove particulate matter and/or water from the hot lubricant.

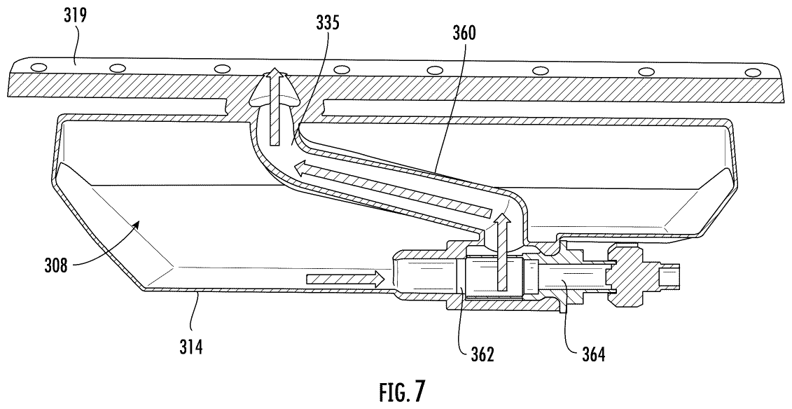

Referring to FIG. 7, the first passageway 335 is defined by a first conduit 360 that extends from the lower wall 314 at an inner end of the sump cavity 308 to the flange 319. In some embodiments, the oil sump 300 is part of an oil sump assembly that also includes a screen 362 and a sensor 364. In the embodiment of FIG. 7 the screen 362 and the sensor 364 are coupled to the first conduit 360 and extend at least partially into the first passageway 335. In some embodiments, the screen 362 includes a perforated plate that is structured to remove particles above a threshold size from the lubricant flowing through the first passageway 335.

In some embodiments, the sensor 364 is a magnetic chip detector that is configured to identify the presence and/or quantity of metal particles in the lubricant passing through the first passageway 335.

Returning to FIG. 6, the second passageway 336 is configured to deliver the hot lubricant from the first passageway 335 to the heat exchanger core 306. In the embodiment of FIG. 6, the second passageway 336 is one of a pair of second passageways (e.g., lubricant directing passageways, etc.) that are configured to direct the lubricant to and from the heat exchanger core 306. A first one of the second passageways 336 defines a lubricant inlet passageway 336a that is structured to direct the hot lubricant (e.g., hot oil, etc.) from the sump cavity 308 and/or fluid conduit and/or filter assembly downstream from the sump cavity 308 (and to the heat exchanger core 306). A second one of the second passageways 336 defines a lubricant outlet passageway 336b that is structured to direct cold lubricant (e.g., cold oil, etc.) at a lower temperature than the hot lubricant away from the heat exchanger core 306.

In the embodiment of FIG. 6, the lubricant inlet passageway 336a and the lubricant outlet passageway 336b are disposed adjacent to one another on the same side of the heat exchanger core 306. In other embodiments, the lubricant inlet passageway 336a and the lubricant outlet passageway 336b are disposed on opposite sides of the flange 319 and are spaced apart from one another by the heat exchanger core 306.

Referring to FIGS. 8-10, the sump body 304 also defines a pair of flow manifolds 313 that are configured to guide lubricant between and across different portions (e.g., regions, sections, etc.) of the heat exchanger core 306. The flow manifolds 313 are shell headers for the heat exchanger 302 that are disposed on either side of the heat exchanger core 306.

In the embodiment of FIG. 8, the pair of flow manifolds 313 includes a first flow manifold 313a disposed on a first side 338 of the heat exchanger core 306 and a second flow manifold 313b disposed on a second side 340 of the heat exchanger core 306 opposite from the first side 338.

The flow manifolds 313 define flow distribution cavities on either side of the heat exchanger core 306. The flow distribution cavities are fluidly coupled to tube passageways defined by the plurality of tubes 322. In the embodiment of FIGS. 8-10, the flow manifolds 313 are integrally formed with the sump body 304 as a monolithic piece (e.g., via an additive manufacturing operation, a casting operation, etc.). In other embodiments, the flow manifolds 313 may be formed separately from the sump body 304, and welded or otherwise secured to the sump body 304. The flow manifolds 313 define opposing sidewalls of the sump body 304.

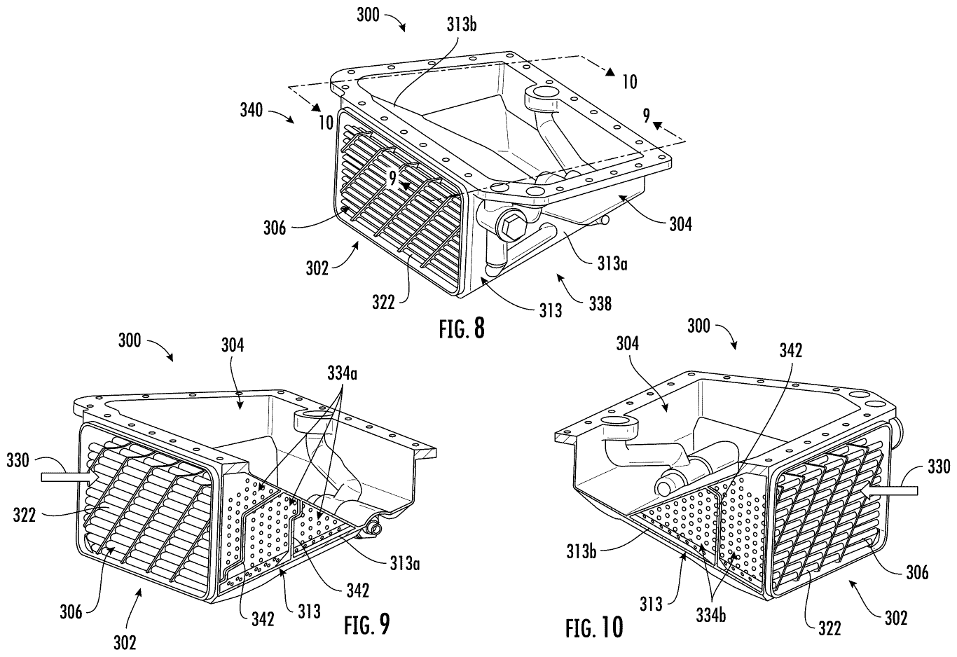

Referring to FIG. 9, the sump body 304 (e.g., the flow manifolds 313, etc.) also includes at least one dividing wall 342 (e.g., flow separation wall, fluid barrier, partition, etc.) that is configured to control the flow of lubricant through different portions of the heat exchanger core 306 (e.g., different bundles of tubes 322, etc.). In the embodiment of FIG. 9, the first flow manifold 313a includes a plurality of dividing walls 342 that extend into the flow distribution cavity of the first flow manifold 313a.

The dividing walls 342 extend in a direction that is substantially normal to the airflow direction 330 through the sump body 304. The dividing walls 342 are spaced apart from one another in approximately equal intervals along the airflow direction 330 through the sump body 304. The dividing walls 342 define a first set of chambers 334a (e.g., a first set of reservoirs, etc.) that extend along the airflow direction 330 through the sump body 304. In the embodiment of FIG. 9, each of the first set of chambers 334a is fluidly coupled to an approximately equal number of tubes 322.

Referring to FIG. 10, the sump body 304 (e.g., the second flow manifold 313b) also includes a dividing wall 342. The dividing wall 342 extends into the flow distribution cavity of the second flow manifold 313b. The dividing wall 342 extends in a direction that is substantially normal to the airflow direction 330 through the sump body 304. In the embodiment of FIG. 10, the second flow manifold 313b includes a single dividing wall 342 defining a second set of chambers 334b (e.g., a second set of reservoirs, etc.). The second set of chambers 334b extend along the airflow direction 330 through the sump body 304. In the embodiment of FIG. 10, each of the second set of chambers 334b is fluidly coupled to an approximately equal number of tubes 322.

The dividing walls 342 within the flow manifolds 313 divide the heat exchanger core 306 into sections. The number and arrangement of dividing walls 342 determines the number of times that lubricant passes through the heat exchanger core 306.

Referring to FIG. 11, a flow diagram 500 of the sump integrated heat exchanger of FIG. 10 is shown, according to an embodiment. As shown in FIG. 11, the dividing walls 542 on either end of the heat exchanger core 506 guide the lubricant back and forth through different portions (e.g., regions, sections, tube bundles, etc.) of the heat exchanger core 506, and so that the flow direction is reversed through each adjacent portion of the heat exchanger core 506. In the embodiment of FIG. 11, the dividing walls 542 separate the heat exchanger core 506 into four portions that are arranged along the airflow direction 530 through the sump body. In such an arrangement, as shown in FIG. 11, the temperature of the lubricant passing through the heat exchanger core 506 decreases along the airflow direction 530 through the sump body.

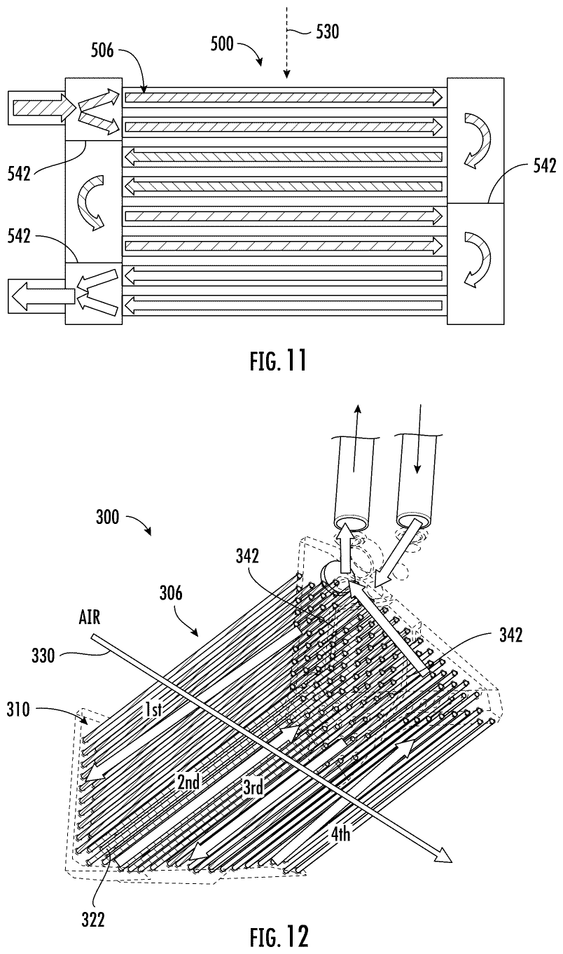

Referring to FIG. 12, a flow diagram showing the flow path of lubricant through the oil sump integrated heat exchanger of FIG. 10 is shown. The dividing walls 342 redirect the flow of lubricant back and forth in a serpentine manner between adjacent portions of the heat exchanger core 306, resulting in an arrangement in which the temperature of the lubricant decreases along the airflow direction 330 through the sump body. It should be appreciated that design of various portions of the heat exchanger integrated oil sump 300 (e.g., the number of dividing walls 342 per side, the diameter and wall thickness of the tubes 322, number of tubes 322, cross-sectional area of the airflow passage 310, etc.) may be different in various embodiments, and depending on application requirements.

Referring to FIG. 13, in some embodiments, the oil sump 300 also includes a bypass system 348 that is configured to bypass the flow of lubricant across the heat exchanger core 306. The bypass system 348 is configured to selectively bypass lubricant across the heat exchanger core 306 based on the temperature of the lubricant in the sump cavity 308, and/or a pressure drop across the heat exchanger core 306. Referring to FIG. 13, the bypass system 348 includes a bypass conduit 350 and a bypass valve 352 that is coupled to the bypass conduit 350 and that is configured to control the flow of lubricant through the bypass conduit 350.

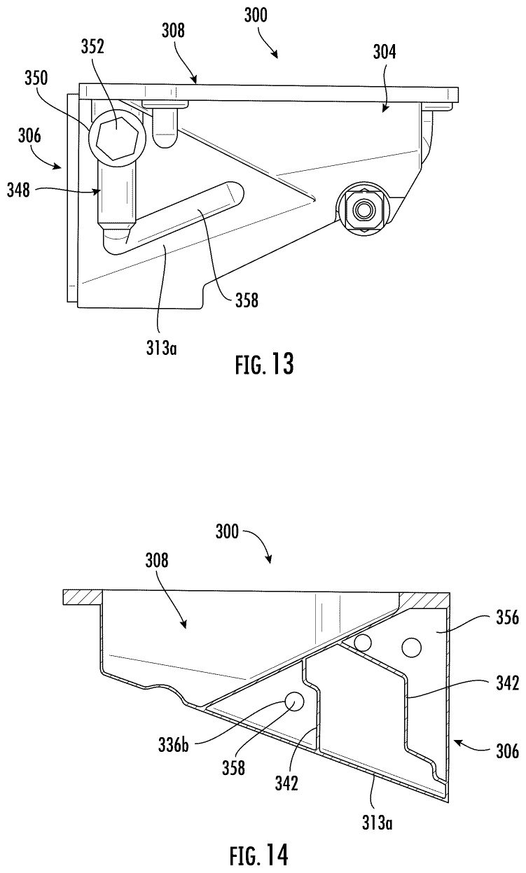

The bypass conduit 350 is fluidly coupled to the first flow manifold 313a on both sides of the at least one dividing wall 342. Referring to FIGS. 13-14, the bypass conduit 350 fluidly couples (i) a first chamber 356 delivering lubricant to an inlet of the heat exchanger core 306, and (ii) an outlet flow conduit 358 that defines the lubricant outlet passageway 336b. In some embodiments, the bypass conduit 350 extends from the outlet flow conduit 358 to the first chamber 356. Such an arrangement can reduce the overall length of conduit needed to bypass the heat exchanger core 306. In other embodiments, the bypass conduit 350 can include a standalone conduit that is separate from the outlet flow conduit 358.

In the embodiment of FIG. 13, the bypass conduit 350 is integrally formed with the sump body 304 as a monolithic piece (e.g., via an additive manufacturing operation, a casting operation, etc.). In other embodiments, the bypass conduit 350 may be formed separately from the sump body 304 and welded or otherwise coupled to the sump body 304.

Referring to FIG. 14, the bypass valve 352 is coupled to the bypass conduit 350 and extends at least partially into the bypass conduit 350. In some embodiments, the bypass valve 352 includes a thermal lockout device. In such an implementation, the bypass valve 352 may be configured to remain open to allow bypass of lubricant across the heat exchanger core 306 if the oil temperature has not reached or otherwise satisfied a threshold temperature value. Such an arrangement can increase system operating efficiency by reducing the pressure drop across the system when no cooling is required.

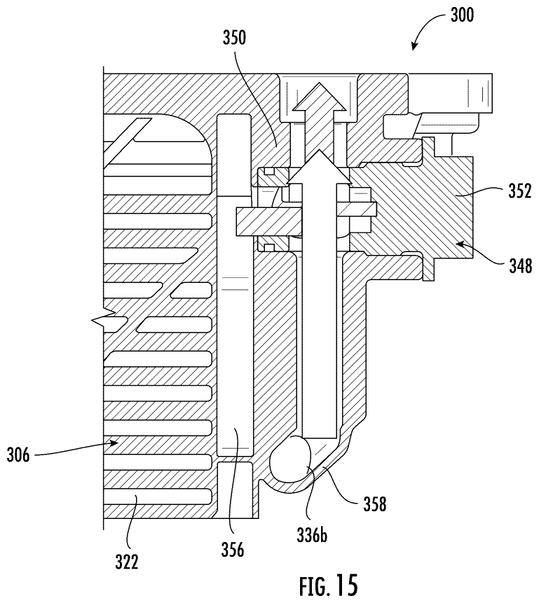

Referring to FIG. 15, in some embodiments, the bypass valve 352 is also configured to operate based on a differential pressure between the inlet and outlet portions of the heat exchanger core 306. In such implementations, the bypass valve 352 may be configured to open in response to a pressure drop across the bypass valve 352 (e.g., between the inlet portion of the heat exchanger core 306 and the outlet portion of the heat exchanger core 306) that exceeds or otherwise satisfies a threshold pressure difference, which can indicate a blockage or other obstruction within the heat exchanger (e.g., within the tubes 322, chambers, etc.).

Notwithstanding the embodiments described above in reference to FIGS. 1-15, various modifications and inclusions to those embodiments are contemplated and considered within the scope of the present disclosure.

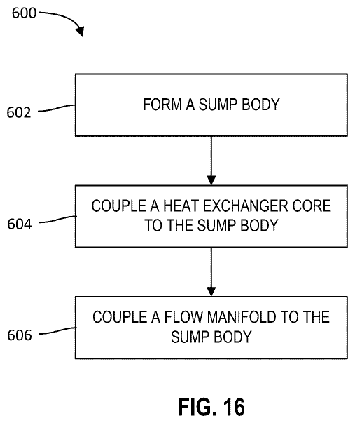

Referring to FIG. 16, a method 600 of making an oil sump for a gearbox assembly is shown, such as the oil sump 300 of FIGS. 3-4 and/or the oil sump 400 of FIG. 5, according to an embodiment.

At operation 602, a sump body is formed. In some embodiments, operation 602 includes forming a lower wall and sidewalls that together define a sump cavity that is configured to receive a volume of oil therein. Operation 602 may also include forming a flange along a perimeter of the sump body at an open end of the sump cavity. In such embodiments, operation 602 may include machining the flange to define a sealing surface that is configured to sealingly engage the sump body with a main housing of a gearbox assembly.

In some embodiments, operation 602 further defines forming an airflow conduit that includes and extends away from the lower wall. The airflow conduit may define an airflow passage that extends through the oil sump and across the lower wall.

At operation 604, a heat exchanger core is coupled to the sump body. In some embodiments, operation 604 includes coupling the heat exchanger core to the sump body so that (i) the heat exchanger core is disposed at least partially within the airflow passage, and (ii) the coolant (e.g., air, etc.) entering the airflow passage is directed across the heat exchanger core. In some embodiments, operation 604 may include integrally forming the heat exchanger core with the sump body using an additive manufacturing process or a casting process.

At operation 606, a flow manifold is coupled to the sump body. In some embodiments, operation 606 includes forming a first flow manifold with the sump body at a first end of the heat exchanger core, and forming a second flow manifold with the sump body at a second end of the heat exchanger core. In some embodiments, operation 606 includes forming at least one dividing wall in the first flow manifold and the second flow manifold to subdivide the heat exchanger core into multiple portions (e.g., regions, sections, etc.). Operation 606 may include integrally forming the first flow manifold and the second flow manifold with the sump body using an additive manufacturing process or a casting process.

In at least one embodiment, the method 600 further includes forming a plurality of flow conduits with the sump body to control routing of lubricant from the sump cavity and through the heat exchanger core. In such implementations, the method 600 may include forming at least one flow conduit that defines a flow passageway extending through the flange of the sump body. In some embodiments, the method 600 further includes forming a bypass conduit that extends between opposing ends of the first flow manifold.

As utilized herein with respect to numerical ranges, the terms “approximately,” “about,” “substantially,” and similar terms generally mean within 5% or 10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such coupling may be mechanical or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. The devices and methods described herein may be embodied in other specific forms without departing from the characteristics thereof. The foregoing implementations are illustrative rather than limiting of the described devices and methods. The scope of the devices and methods described herein is thus indicated by the appended claims, rather than the foregoing description, and changes that come within the meaning and range of equivalency of the claims are embraced therein.

What is claimed is:

1. A gearbox assembly, comprising:
a main housing defining an internal cavity;
a plurality of gears disposed within the internal cavity; and
a lubricant sump coupled to the main housing, the lubricant sump comprising:
a sump body defining:
a sump cavity that is fluidly coupled to the internal cavity to collect lubricant used with the plurality of gears; and
an airflow passage; and
a heat exchanger core coupled to and extending from the sump body and disposed at least partially within the airflow passage to cool the lubricant passing through the heat exchanger core.

2. The gearbox assembly of claim 1, wherein the heat exchanger core comprises a plurality of tubes that are disposed at least partially within the airflow passage.

3. The gearbox assembly of claim 1, wherein the heat exchanger core and the sump body are integrally formed from a single piece of material.

4. The gearbox assembly of claim 1, wherein the sump body further defines a wall defining at least a portion of the sump cavity and at least a portion of the airflow passage.

5. The gearbox assembly of claim 1, wherein the sump body further defines a flow manifold on a first side of the heat exchanger core.

6. The gearbox assembly of claim 5, wherein the sump body further comprises a dividing wall disposed within the flow manifold and fluidly separating a first portion of the heat exchanger core from a second portion of the heat exchanger core.

7. The gearbox assembly of claim 6, further comprising:
a bypass conduit fluidly coupled to the flow manifold on both sides of the dividing wall; and
a bypass valve coupled to the bypass conduit and configured to control fluid flow through the bypass conduit.

8. The gearbox assembly of claim 1, wherein the sump body further defines a plurality of fluid passageways including a first fluid passageway that is fluidly coupled to the sump cavity, and a second fluid passageway that is fluidly coupled to the heat exchanger core.

9. The gearbox assembly of claim 8, wherein the sump body further defines a flange that is structured to couple the sump body to the main housing, wherein the plurality of fluid passageways extend through the flange.

10. The gearbox assembly of claim 8, further comprising a fan structured to circulate air through the airflow passage.

11. A lubricant sump for a gearbox assembly, comprising:
a sump body defining:
a flange structured to couple the sump body to a housing of the gearbox assembly;
a sump cavity configured to receive a volume of lubricant therein; and
an airflow passage; and
a heat exchanger core coupled to and extending from the sump body and disposed at least partially within the airflow passage to cool the lubricant passing through the heat exchanger core.

12. The lubricant sump of claim 11, wherein the heat exchanger core comprises a plurality of tubes that are disposed at least partially within the airflow passage.

13. The lubricant sump of claim 11, wherein the heat exchanger core and the sump body are integrally formed from a single piece of material.

14. The lubricant sump of claim 11, wherein the sump body further defines a wall defining at least a portion of the sump cavity and at least a portion of the airflow passage.

15. The lubricant sump of claim 11, wherein the sump body further defines a flow manifold on a first side of the heat exchanger core.

16. The lubricant sump of claim 15, wherein the sump body further comprises a dividing wall disposed within the flow manifold and fluidly separating a first portion of the heat exchanger core from a second portion of the heat exchanger core such that the flow of the lubricant through the first portion is in a first direction and the flow of the lubricant in the second portion is in a second direction other than the first direction and a temperature of the lubricant decreases along an airflow direction through the sump body.

17. The lubricant sump of claim 16, further comprising a bypass conduit fluidly coupled to the flow manifold on both sides of the dividing wall.

18. The lubricant sump of claim 11, wherein the sump body further defines a plurality of fluid passageways including a first fluid passageway that is fluidly coupled to the sump cavity, and a second fluid passageway that is fluidly coupled to the heat exchanger core, wherein the plurality of fluid passageways extend through the flange.

19. A method of making a lubricant sump for a gearbox assembly, comprising:
forming a sump body defining:
a flange structured to couple the sump body to a housing of the gearbox assembly;
a sump cavity configured to receive a volume of lubricant therein; and
an airflow passage; and
coupling a heat exchanger core to the sump body so that the heat exchanger core is disposed at least partially within the airflow passage.

20. The method of claim 19, wherein forming the sump body comprises forming a wall that defines at least a portion of the sump cavity and at least a portion of the airflow passage.
